(19) United States
(12) Patent Application Publication
(10) Pub. No.: US 2014/0372932 A1
(43) Pub. Date: Dec. 18, 2014

(54) Filtering Data with Slicer-Style Filtering User Interface

(71) Applicant: Microsoft Corporation, Redmond, WA (US)

(72) Inventors: Allison Jane Rutherford, Seattle, WA (US); John Campbell, Renton, WA (US); Uhl Albert, Kirkland, WA (US)

(21) Appl. No.: 13/918,904

(22) Filed: Jun. 15, 2013

(51) Int. Cl. G06F 3/0483

(52) U.S. Cl. CPC G06F 3/0483
USPC 715/776

(57) ABSTRACT

A slicer-style filtering user interface is provided that allows for advanced filtering and sorting of data and that may be utilized with a touch or gesture based computing device. The slicer-style filtering user interface may be invoked on a spreadsheet data range for filtering and sorting data according to desired properties. A slicer-style filtering user interface may be moved about on a displayed spreadsheet document for ease of use in proximity to one or more data items. If a theme or style is applied to a given spreadsheet document, the invoked slicer-style filtering user interface may be automatically themed or styled to match the document. The slicer-style filtering user interface may be operable for advanced filtering, and the user interface may be efficiently changed from one filtering type to another filtering type.

### BACKGROUND

With the advent of computers and computer software, users have become accustomed to receiving, entering, editing, filtering and otherwise utilizing data of various types. Spreadsheet applications have become very popular for allowing users to handle large amounts of data and for performing many different computations and data organization functions. Data filtering may be performed using various methods including application of various filtering properties or filtering types from a menu of filtering types or with a slicer-style filter that allows users to filter tables of data. Unfortunately, selecting a filtering property from a menu may allow for filtering a given range of data, but a current filtering state may be difficult to realize, and use of a slicer-style filter may provide information on a current filter state, but does not allow for sorting and advanced filtering. Moreover, in currently available systems, neither type of filtering method works well with touch or gesture based computing devices that are becoming increasingly popular. Thus, an improvement and technical advantage would be gained by providing a slicer-style filtering system and method that allows for advanced filtering and sorting of data and that may be efficiently utilized with a touch or gesture based computing device.

It is with respect to these and other considerations that the present invention has been made.

### SUMMARY

This summary is provided to introduce a selection of concepts in a simplified form that are further described below in the detailed description. This summary is not intended to identify key features or essential features of the claimed subject matter, nor is it intended as an aid in determining the scope of the claimed subject matter.

Embodiments of the present invention provide a slicer-style filtering system and method that allows for advanced filtering and sorting of data and that may be efficiently utilized with a touch or gesture based computing device. According to embodiments, a slicer-style filtering user interface may be invoked on a spreadsheet data range for filtering and sorting data according to desired properties. A slicer-style filtering user interface may be moved about on a displayed spreadsheet document for ease of use in proximity to one or more data items contained in the displayed document. If a theme or style is applied to a given spreadsheet document, the invoked slicer-style filtering user interface may be automatically themed or styled to match the document. The slicer-style filtering user interface may be operable for advanced filtering, and the slicer-style filter user interface may be efficiently changed from one filtering type to another filtering type, as desired.

The details of one or more embodiments are set forth in the accompanying drawings and description below. Other features and advantages will be apparent from a reading of the following detailed description and a review of the associated drawings. It is to be understood that the following detailed description is explanatory only and is not restrictive of the invention as claimed.

### BRIEF DESCRIPTION OF THE DRAWINGS

The accompanying drawings, which are incorporated in and constitute a part of this disclosure, illustrate various embodiments of the present invention.

FIG. 1 illustrates a system architecture in which embodiments of the present invention may be practiced.

FIG. 2 illustrates an electronic spreadsheet document including a variety of data items.

FIG. 3 illustrates the electronic spreadsheet document of FIG. 2 and illustrates an invoked slicer-style filtering user interface.

FIG. 4 illustrates the electronic spreadsheet document of FIG. 3 showing a selection of all filtering properties in the slicer-style filtering user interface.

FIG. 5 illustrates the electronic spreadsheet document of FIG. 4 showing one filtering property de-selected in the slicer-style filtering user interface.

FIGS. 6 and 7 illustrate a movement of the slicer-style filtering user interface from one location in the illustrated document to a different location.

FIGS. 8 and 9 illustrate a movement of the slicer-style filtering user interface from one location in the illustrated document to a different location.

FIG. 10 illustrates a themed electronic spreadsheet document and illustrates application of a document theme to a displayed slicer-style filtering user interface.

FIG. 11 illustrates a slicer-style filtering user interface and illustrates selection of one or more different filtering types.

FIG. 12 illustrates a slicer-style filtering user interface and illustrates selection of one or more different filtering types.

FIG. 13 illustrates a slicer-style filtering user interface and illustrates selection of one or more different filtering types.

FIG. 14 is a flowchart illustrating a method for providing and utilizing a slicer-style filtering user interface.

FIG. 15 is a block diagram illustrating example physical components of a computing device with which embodiments of the invention may be practiced.

FIGS. 16A and 16B are simplified block diagrams of a mobile computing device with which embodiments of the present invention may be practiced.

FIG. 17 is a simplified block diagram of a distributed computing system in which embodiments of the present invention may be practiced.

### DETAILED DESCRIPTION

As briefly described above, embodiments of the present invention are directed to a slicer-style filtering user interface that may be utilized for filtering and sorting a variety of data items in an electronic spreadsheet document according to one or more different filtering and sorting properties. The following detailed description refers to the accompanying drawings. Wherever possible, the same reference numbers are used in the drawings and the following description to refer to the same or similar elements. While embodiments of the invention may be described, modifications, adaptations, and other implementations are possible. For example, substitutions, additions, or modifications may be made to the elements illustrated in the drawings, and the methods described may be modified by substituting, reordering, or adding stages to the disclosed methods. Accordingly, the following detailed description does not limit the invention but, instead, the proper scope of the invention is defined by the appended claims.

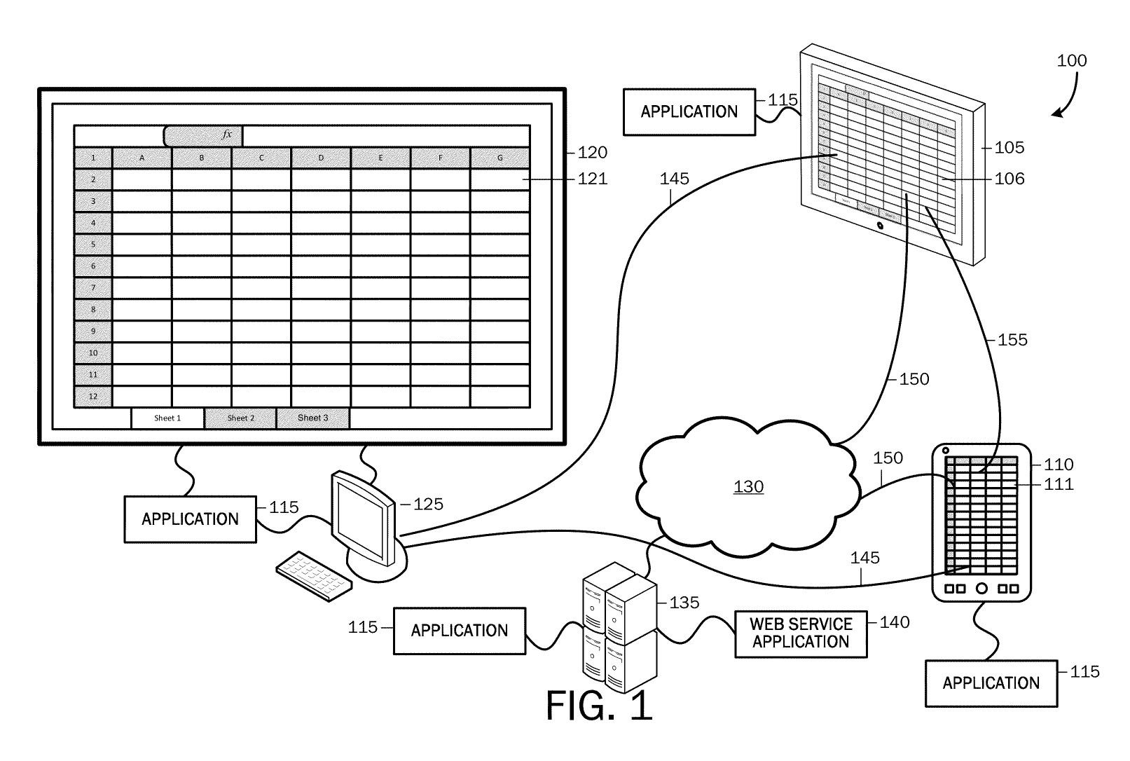

FIG. 1 illustrates a system architecture in which embodiments of the present invention may be practiced. In FIG. 1, a variety of computing devices are illustrated with which embodiments of the present invention may be practiced on individual computing devices or in a collaborative work session. For example, a small-form smartphone or other handheld computing device 110 is illustrated having a display surface 111 and being associated with an application 115. A larger form tablet-style computing device 105 having a display surface 106 and an associated spreadsheet application 115 is illustrated. A large display device 120 having a display surface 121 is illustrated being associated with a computer 125 and a spreadsheet application 115.

As should be appreciated, the computing devices 105, 110, 120, 125 are purposes of illustration only and are not exhaustive of the various types of computing devices that may be used in accordance with embodiments of the present invention. For example, while the display device 120 is illustrated as a display unit with an associated computing device 125, the large-form display device 120 may operate as an integrated display/computing device that may be used for any suitable use from large-scale display uses, for example, in a conference room, to personal computing, as desired. According to embodiments, each of the computing devices illustrated in FIG. 1 may receive input through a variety of suitable means including touch or gesture input, keyboard input, mouse input, voice command input, electronic inking input, and the like.

Referring still to FIG. 1, the software applications 115 illustrated in association with each of the computing devices 105, 110, 120, 125 are illustrative of any application having sufficient computer executable instructions for enabling embodiments of the present invention as described herein. For example, applications 115 may include spreadsheet applications, word processing applications, slide presentation applications, electronic mail applications, notes taking applications, desktop publishing applications, and the like. An example spreadsheet application 115 includes EXCEL manufactured by Microsoft Corporation of Redmond, Wash. As should be appreciated, this example spreadsheet application is but one example of the many applications suitable for enabling embodiments described herein may be used.

Each of the computing devices 105, 110, 120, 125 may operate in a collaborative work environment through one or more wired or wireless data connections 145, 150, 155. That is, each of the computing devices may communicate with each other through wired or wireless data lines via direct connection, or via connection through a distributed computing network 130 such as an Internet or intranet.

According to embodiments, application functionality associated with each of the computing devices 105, 110, 120, 125 may operate according to one or more variations. For example, each application 115 may be a fully functional “thick” client application having all application functionality including the ability to send and receive data to and from other applications 115 operating on other computing devices in the collaborative work session. Each such application not only has its native functionality, for example, spreadsheet functionality, but according to embodiments of the present invention, each such application also contains sufficient computer executable instructions for allowing each application to operate as a control application for controlling information sent from a control device for receipt by an endpoint display device in a collaborative work environment. Likewise, each such application has sufficient computer executable instructions for allowing the application to operate as an endpoint display device for receiving control functions from another computing device.

According to another embodiment, the computing devices 105, 110, 120, 125 may communicate via a distributed computing network 130, for example, the Internet. Referring still to FIG. 1, the computing device 135 is illustrative of an Internet-based or “cloud-based” server computer on which may be operated one or more web services applications 140 for providing a collaborative work session, as described herein. According to this embodiment, each of the devices 105, 110, 120, 125 may operate as thin client systems, and collaborative communication between the devices may be operated at the direction of the web services application 140 operated at a remote site. According to this embodiment, an application 115 may operate at the remote server 135 wherein each of the devices 105, 110, 120, 125 may access and receive the functionality described herein via a remote service from the server based application 115, for example, via the web services application 140.

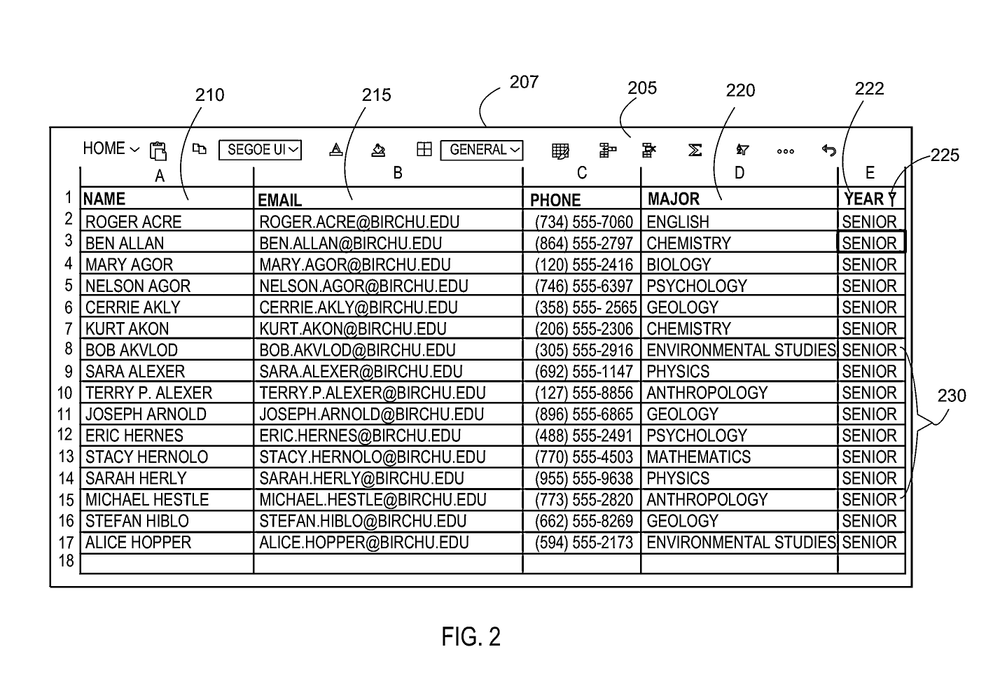

In FIG. 2, an example spreadsheet document 205 is illustrated that may be displayed on any suitable computing device 105, 110, 120, 125 described above. According to embodiments described herein, user interaction with the electronic spreadsheet document 205 may be accomplished via a variety of interaction methods including keyboard entry, mouse entry, punch entry, gesture entry, voice command, or combinations thereof. The electronic spreadsheet document 205 is for purposes of example and illustration only and is not exhaustive of a variety of types of documents that may contain data for which the slicer-style filtering user interface of the present invention may be utilized. For example, while embodiments described herein discuss the slicer-style filtering user interface in terms of its operation in association with data contained in a spreadsheet application document, other documents, for example, word processing documents containing data that may be filtered and/or sorted, slide presentation documents that contain data that may be filtered and/or sorted, electronic mail applications containing data or other items that may be filtered and/or sorted, notes applications that may contain data that may be filtered and/or sorted, or any other document type that may contain data that may be filtered and/or may utilize the slicer-style filtering user interface described herein.

Referring still to FIG. 2, the example spreadsheet document 205 includes a number of columns of data 210, 215, 220, 222. For example, the data illustrated in the document 205 includes various names, electronic mail addresses, telephone numbers, education majors and education year designators that may be typical of data maintained on a variety of students at a given educational institution. As should be appreciated, the data illustrated in FIG. 2 is for purposes of example only and is not exhaustive of the vast amounts of data that may be organized in a spreadsheet or other document and for which the slicer-style filtering user interface of the present invention may be utilized.

The user interface 207 in which the document 205 is displayed is illustrative of a user interface of any suitable software application, as described above, for displaying the electronic document 205 and for enabling use of one or more functionalities of the associated application 115 in association with the various data items contained in the document 205. Such functionalities may include data entry, data editing, data formatting, data computation, data receipt, data transmission, and the like.

According to embodiments of the present invention, data contained in the document 205 may be filtered and/or sorted according to a variety of filtering and/or sorting methods. As well known to those skilled in the art, a sorting function may allow for a variety of data items to be ordered according to a sorting property, for example, sorted from highest to lowest, ascending order, descending order, sorted by year, sorted alphabetically, and the like. On the other hand, a filtering function allows for generating a listing of data items of a selected type while blocking out data items of another type. For example, filtering the student information illustrated in the example document 205 according to an English major may cause a display of a listing of all students along with their associated information who are majoring in English, while blocking out from the listing all students majoring in some other educational course.

Referring still to FIG. 2, the example student data illustrated in the document 205 has been sorted according to education year, for example, senior, junior, sophomore, freshman. Because the data has been sorted based on education year in descending order, all students who are seniors are listed first, followed by all students who are juniors, followed by all students who are sophomores, followed by all students who are freshman, and the like. According to one embodiment, each example column of data may be sorted by selecting on the column header situated above each column of data. For example, by selecting the column header of “Name” for the column 210, all data items contained in the document 205 may be sorted alphabetically by student name. Likewise, by selecting the column header of “Major” for the column 220, all the data contained in the document 205 may be sorted according to a student's major, and so on. In addition, primary, secondary, tertiary and so on sorting properties may be utilized, for example, where a set of data is sorted first by a first property, for example, name, followed by sorting the data by a second property, for example, major, and the like.

For filtering the data contained in the document 205 without the use of the slicer-style filtering user interface, described herein, a filtering user interface component may be selected from the functions available to the application 115 for allowing the data contained in the document 205 to be filtered according to various filtering properties where certain data may be filtered-in (i.e., maintained in the document) and where certain data may be filtered-out (i.e., discarded from the present display), and the like. For example, if the data illustrated in the document 205 is filtered according to all students who are English majors, then data for all students who are English majors will be maintained in the listing in the document 205, and data for all students who are not English majors will be filtered-out or discarded from the current listing illustrated in the document 205. As should be appreciated, when a data item is filtered-out of the current displayed listing, the filtered out data is not discarded from memory, but is simply removed from the presently filtered display of data items. Upon changing the filter property, as desired, such filtered-out data may be brought back into the displayed listing of data, as desired.

As illustrated in FIG. 2, the primary means for determining the current filter state applied to the data illustrated in the document 205 is by reviewing the data to determine what types of data are listed versus what types of data are not listed. For example, by a review of the data listed in the example spreadsheet 205, it can be seen that only data for students who are seniors is listed, and therefore, the user may conclude that the data has been filtered to show only seniors or that the data has been sorted by year group and that data for seniors only is currently displayed in the document 205.

According to embodiments of the present invention, a slicer-style filtering user interface may be provided with which data may be filtered and sorted according to various filtering and sorting properties and that may be moved around on the displayed document 205 as a floating user interface component for allowing ease of use of the filtering and sorting functionalities in association with one or more data items contained in the document. Referring still to FIG. 2, a slicer-style filtering user interface may be launched or invoked on a given set of data items according to a variety of methods.

According to one embodiment, a slicer-style filtering user interface selection icon 225 may be displayed next to each column header for allowing the slicer-style filtering user interface to be displayed for each column of data. As should be appreciated, the slicer-style filtering user interface may be utilized for other arrangements of data, besides the example columns of data illustrated in FIG. 2. According to one embodiment, the selectable icon 225 may be displayed to a user when the user focuses on a given column header, for example, by mouse over, single tap, gesture, voice command, and the like. Alternatively, the icon 225 may be displayed at all times adjacent to the column headers, as illustrated for the year column 222. Alternatively, invocation of the slicer-style filtering user interface may be performed by other methods, for example, selection of a filtering and/or sorting function from a menu of functions, selection of a filtering and/or sorting icon in a displayed array of application functionality controls, and the like.

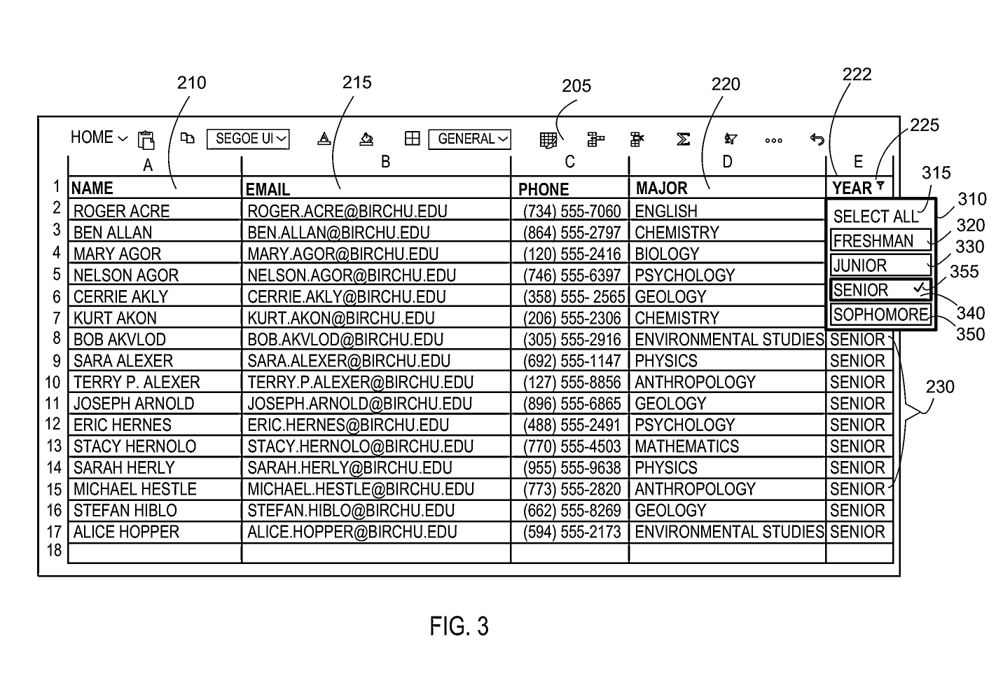

Referring now to FIG. 3, after selection of the icon 225 or other appropriate user interface invocation method or control, the slicer-style filtering user interface 310 is launched for use in association with a selected range of data items. The slicer-style filtering user interface 310 includes a functionality control area 315 in which one or more filtering and/or sorting selectable functionalities may be disposed. As illustrated in FIG. 3, a “Select All” button is displayed for allowing a user to selectively filter a range of data according to all available filtering properties, as described below. As should be appreciated, other filtering properties and/or functionalities controls may be disposed in the control area 315, for example, a “Clear” function for clearing a filtering or sorting property, as well as, one or more other filtering or sorting properties that may be applied to a selected range of data. That is, any available filtering and/or sorting functionality that may be operated according to the functionalities of the application 115 may be displayed in the control area 315 for selectively applying various filtering and/or sorting properties to a selected range of data.

According to one embodiment, when the user interface 310 is invoked for operation on a given data range, for example, a given column of data, the column header, for example, “Year” displayed above the example column 222 may be highlighted, colored, underlined, italicized, or otherwise visually altered to indicate that the presently invoked slicer-style filtering user interface is associated with that range of data. As will be described below, because the user interface 310 may be moved to a different location in the document, as desired by the user, visually indicating the range of data to which the user interface 310 is presently associated assists the user in tracking the selected data range relative to the present filtering operation.

Referring still to the displayed slicer-style filtering user interface 310, a number of tiles 320, 330, 340, 350 are illustrated and correspond to available filtering properties that may be applied to the selected range of data. For example, the selected range of data in the document 205 includes the column 222 containing the year designations for each of the example students. Thus, tiles 320, 330, 340, 350 identified in the example instance of the user interface 310 include tiles for freshman, sophomore, junior and senior. As should be appreciated, if the user interface 310 was invoked on the data contained in the example column D containing majors of the example students, then the tiles 320, 330, 340, 350 may include designations for each major provided for the list of students to allow filtering on each of the available majors. Thus, a quick glance at the identified tiles 320-350 provided in the user interface 310 provides the user immediate feedback on the different data types contained in the selected data range.

According to one embodiment, the type of filtering properties that are shown in terms of the displayed tiles may be shown by default is dependent on the data type of the column of data for which the filtering user interface is invoked. Specialized filters may be available by default for different data types, for example, date columns may have date range selection instead of a unique item tile selection as may be default for text.

According to embodiments, the arrangement of the tiles 320-350 in the user interface 310 and visual information associated with one or more of the tiles 320-350 may provide immediate visual feedback as to any filtering properties presently applied to the selected data range. That is, the present filtering state of the data range may be immediately realized by a review of the selected or un-selected tiles displayed in the user interface 310. As illustrated in FIG. 3, the senior tile 340 is highlighted, and a checkmark 355 is displayed in the tile. The highlighting of the senior tile 340 and the displayed checkmark 355 visually distinguish the as associated with filtering properties presently applied to the data range. For example, the highlighting indicates that the present filtering state for the selected data range includes filtering the selected data range according to students in the senior class. That is according to this example filtering state, data for seniors only will be listed in the document 205, and data for other students will not be listed in the document 205.

According to the illustrated user interface 310, the other filtering properties (e.g., freshmen, sophomore, and junior) remain displayed, and the associated tiles are indicated as not selected at the present time. Other indications, for example, graying out or ghosting tiles associated with data that has been filtered-out of the present display may be utilized. As should be appreciated, the use of highlighting or the use of an icon, for example, a checkmark 355 to indicate a present filtering state is for purposes of illustration and example only and is not exhaustive of other suitable methods for indicating a presently selected filtering state.

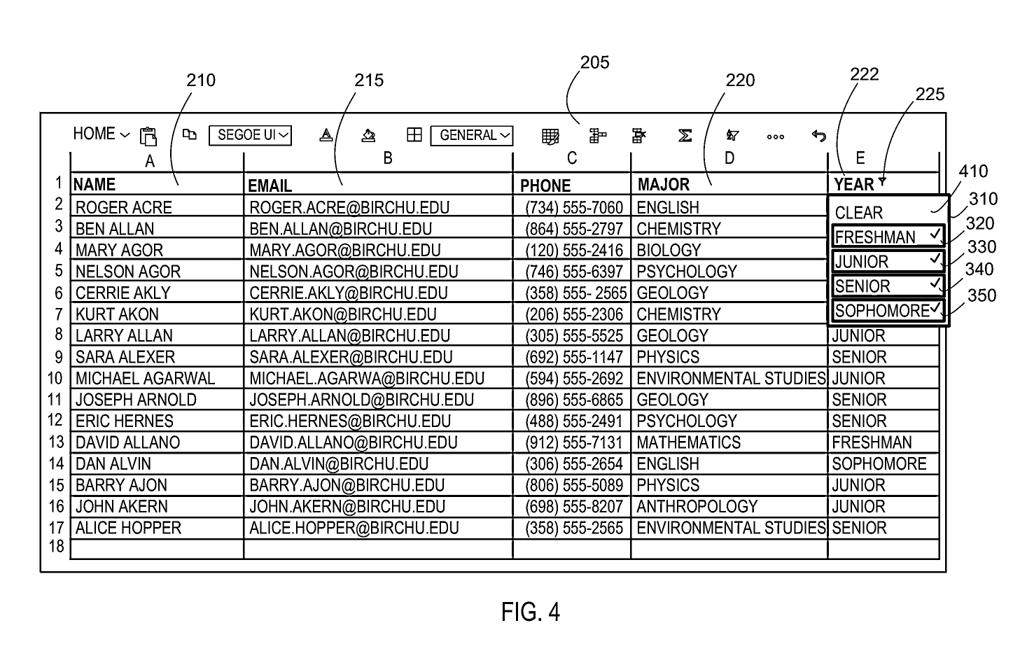

According to embodiments, if a user desires to remove the present filtering property, the user may tap on the highlighted tile (e.g., senior tile) 340, or otherwise actuate the tile (e.g., keyboard entry, mouse click, and the like), and the associated filtering property will be removed as a filtering property. In response, the associated data will be returned to a display as unfiltered data as it was displayed prior to selection of the example senior class filtering property. As should be appreciated, the user may then select a different tile, for example, the junior tile 330, for filtering the data for showing only students who are members of the junior class. If desired, the user may select any or all of the tiles 320, 330, 340, 350 individually, and as each tile is selected, the underlying data may be dynamically filtered based on each additional filtering property applied through interaction with the user interface 310. Alternatively, if the user desires to filter the data according to all of the available filtering properties, the user may select the “Select All” button or control from the control area 315, as illustrated and described below with reference to FIG. 4.

According to embodiments, in addition to filtering information and associated selectable tiles, as illustrated in FIG. 3, information may be provided in the user interface 310 as to one or more sorting properties applied to the selected data range. For example, if the selected data range has not been filtered, but the selected data range has been sorted in ascending order, then the tiles 320, 330, 340, 350 may be displayed in the user interface 310 according to the sorting property presently applied to the selected data range.

According to embodiments, the slicer-style filtering user interface 310 may be resized as desired by a user and/or depending upon the available display space on the user's computing device 105, 110, 120, 125. For example, if the user interface 310 is invoked for the data contained in column 220 containing educational majors for the example students, owing to the large number of different educational majors, tiles for each educational major may not fit in the display of the user interface 310 on a small-form computing device. Alternatively, if the document 205 is displayed on a large-form display 120, the user interface 310 may be resized to show all tiles for all filtering types associated with the selected data range.

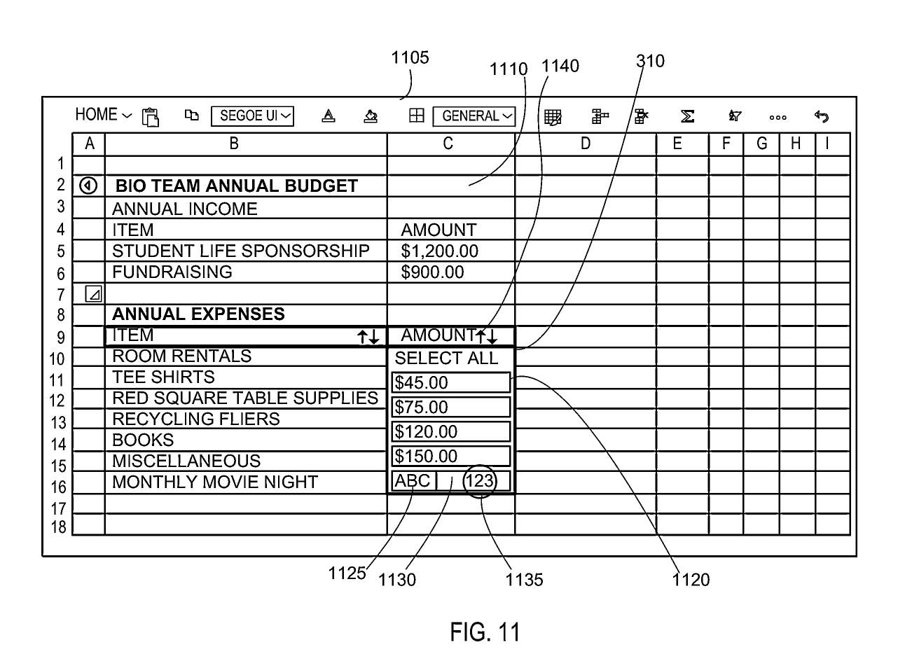

According to one embodiment, the display size for the user interface 310 may be automatically set for initially displaying a predetermined set of tiles (e.g., five tiles), or the user interface 310 may be sized automatically by the application 115 depending upon the available display space associated with the computing device 105, 110, 120, 125. According to embodiments, if the display size for the user interface 310 is not large enough for displaying all tiles associated with all filtering properties available for a selected data range, a scrolling function may be provided for the user interface 310 for allowing the user to scroll through all available formatting properties and associated tiles available in the user interface 310. According to another embodiment, and as described further below with reference to FIGS. 11-13, where more advanced filtering functions are available for a given set of data items, additional filtering tiles may be available in the displayed user interface 310 to the right or to the left of presently displayed tiles, and therefore, a user may horizontally pan to the right or to the left in the user interface 310 for displaying other available filtering tiles and associated filtering properties that may be applied to the selected data range.

According to embodiments, the displayed slicer-style filtering user interface 310 may be dismissed from display according to a variety of suitable methods. For example, a dismissal icon may be displayed in the control area 315 that may be used for selectively dismissing the displayed user interface 310. According to another embodiment, the user interface 310 may be dismissed by tapping or selecting in an area of the displayed document 205 outside of the user interface 310. As should be appreciated, these are but examples of suitable methods for dismissing a given user interface component from display, as illustrated in FIG. 3.

Referring now to FIG. 4, the slicer-style filtering user interface 310 is illustrated showing all tiles 320, 330, 340, 350 highlighted and showing checkmark icons displayed in each tile. According to this example display, all filtering properties available in the user interface 310 have been selected, by individual selection, or by selecting a “Select All” function, described above. As illustrated in FIG. 4, after all available filtering properties are selected, the data contained in the example spreadsheet 205 may be immediately and dynamically reordered and/or redisplayed based on the current filtering state for the data. As described above, the highlighting or other visual indication of a selection of one or more of the filtering property tiles gives a reviewing user instant feedback as to the present filtering state applied to the selected data range. Thus, upon review of the user interface 310, as illustrated in FIG. 4, a user will immediately understand that the data has been filtered to show information for freshmen, sophomore, junior, and senior students. In response to a selection of all available filtering tiles, the “Select All” button may be replaced with a “Clear” button 410, for allowing a user to selectively clear all presently applied filtering properties, as desired.

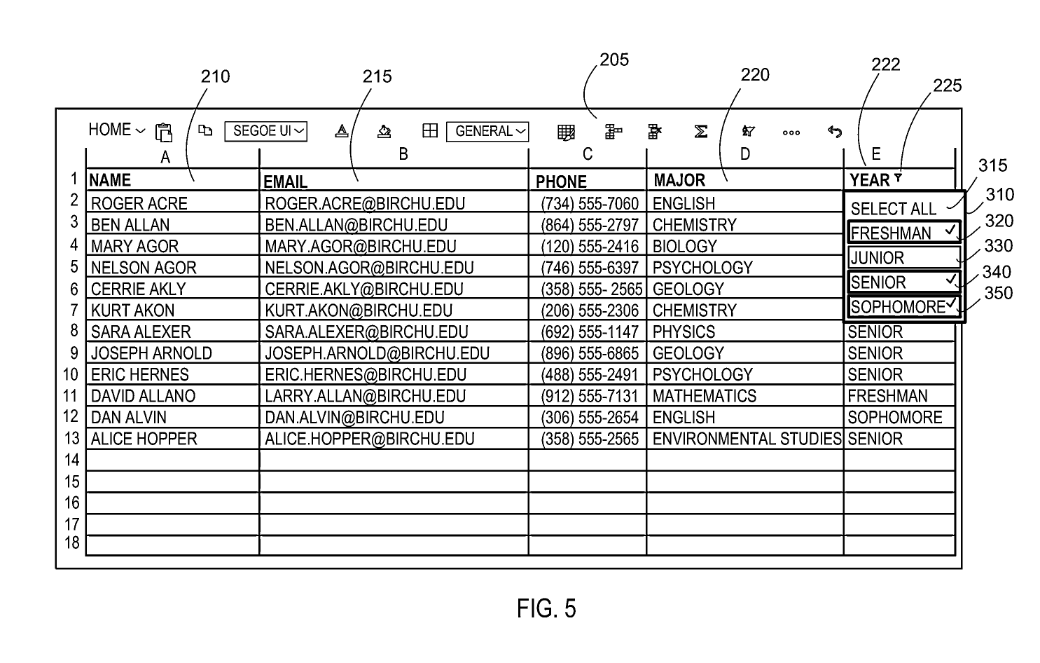

Referring now to FIG. 5, a selected filtering property tile may be de-selected, and the associated filtering property will be immediately and dynamically removed from the filtering of the selected data range. As illustrated in FIG. 5, the user has tapped or otherwise selected the junior filtering tile 330, and as a result, the data has been immediately and dynamically filtered such that the data associated with the de-selected filter tile is filtered out of the selected data range. For example, referring to FIG. 5, after the junior tile 330 is de-selected, data for only those students belonging to the freshmen, sophomore and senior classes is displayed in the filtered list. As briefly described above, according to other embodiments, if a data item is filtered out of a given data range, the de-selected tile may be grayed out or ghosted to indicate that data associated with the de-selected tile is no longer displayed in the selected data range. As should be appreciated, if the user de-selects another of the presently selected filtering tiles, then the data will be similarly filtered again to filter out data associated with the de-selected tile.

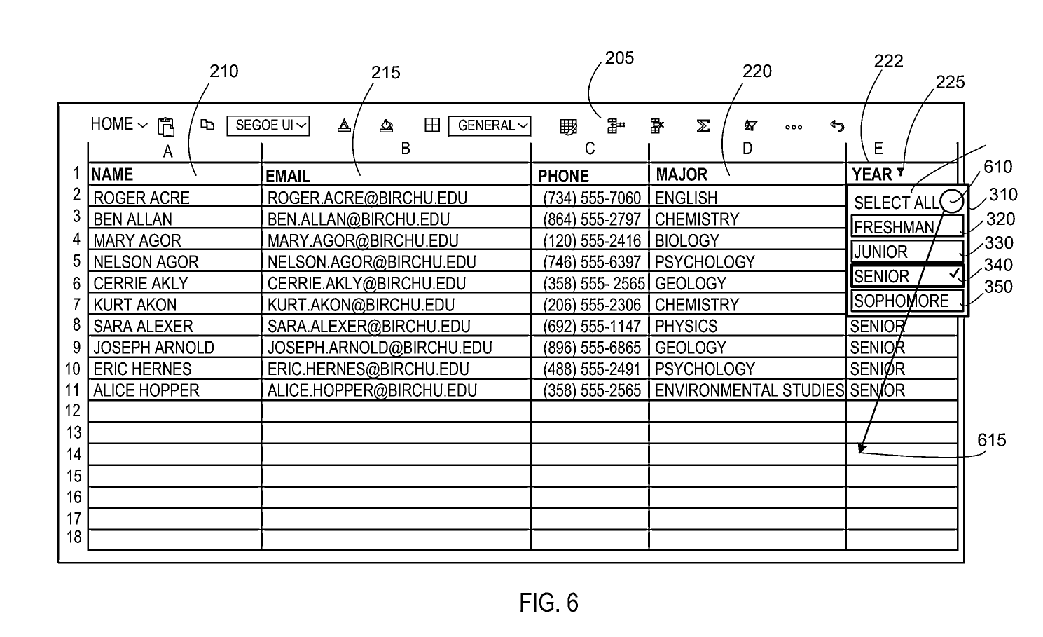

Referring now to FIG. 6, according to embodiments of the present invention, the slicer-style filtering user interface 310 may operate as a floating user interface component wherein the user may drag and drop or otherwise move the user interface 310 from one location overlaying a document 205 to a second location. Once the user interface 310 is moved to a different location, it may be docked at the new location until it is moved to yet a different location. As should be appreciated, it may be desired under a number of different circumstances to move interface 310 to a different position on the document 205. For example, if the user's computing device 110 is a small-form device, for example, a smart phone, a display of the user interface 310 may overlay portions of the user's data in a manner that prevents the user from looking at her data and at the user interface simultaneously. Thus, in such a situation, it may be helpful to move the user interface 310 to a different location to allow the user to review the underlying data. On the other hand, if the user is using a large-form computing device 120, as illustrated above with reference to FIG. 1, the user interface 310 may be moved to a different position on the display to move the user interface closer to a given data item or range of data items the user is reviewing to allow the user to make filtering and/or sorting decisions on the reviewed data in close proximity to the user interface 310.

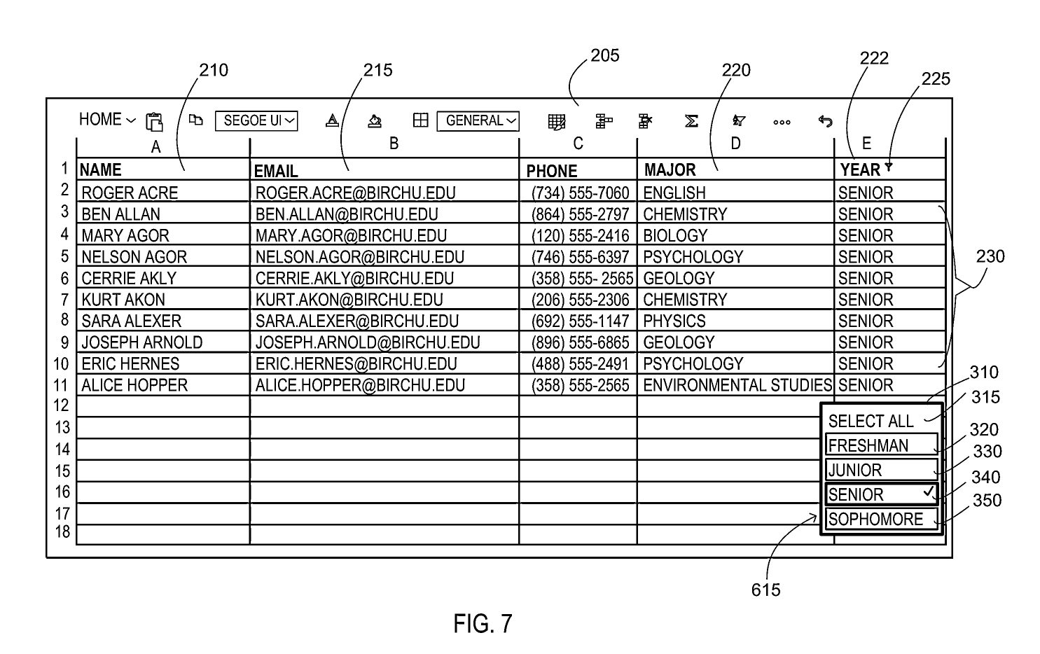

In order to move the user interface 310 from a presently docked position to a second or different position, the user may drag and drop the user interface from a starting position, as illustrated in FIG. 6, to a different position 615. That is, the user interface may be undocked from the first position and docked at the second position. According to one embodiment, the user may tap and hold on a portion of the user interface 310 not associated with a selectable control, followed by dragging the user interface 310 to a different location 615, as illustrated in FIG. 7. As should be appreciated, the drag/drop functionality that may be utilized for moving the user interface 310 may be performed according to a variety of methods. For example, according to a touch or gesture method, a user may tap the user interface 310 with a finger, stylus, or other selection object followed by dragging or pulling the user interface 310 from a starting position to a different position.

When the user interface 310 is dropped at the secondary or different position 615, as illustrated in FIG. 7, the user interface 310 may then be docked at the different position until it is subsequently moved to a different location. According to other methods, the user interface 310 may be dragged and dropped from the starting position to the different location using mousing actions, voice commands, gestures, keyboard entries, or any other suitable means for interacting with the user interface 310 as a moveable object overlaying the displayed document 205 according to the functionality of the application 115 responsible for enabling a display of the user interface 310 and the document 205.

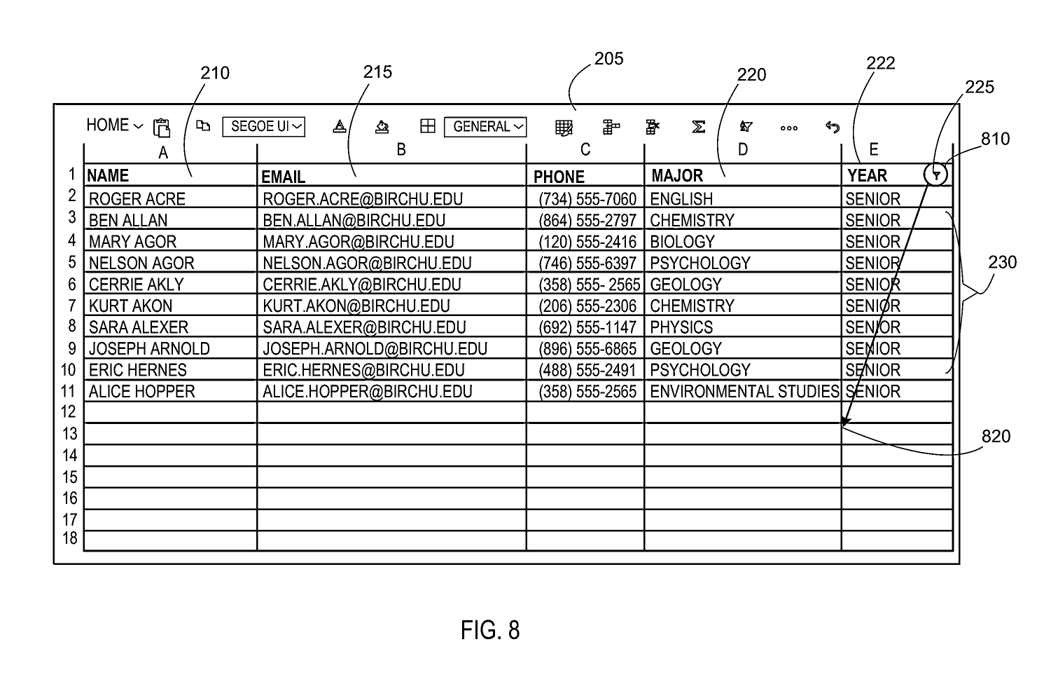

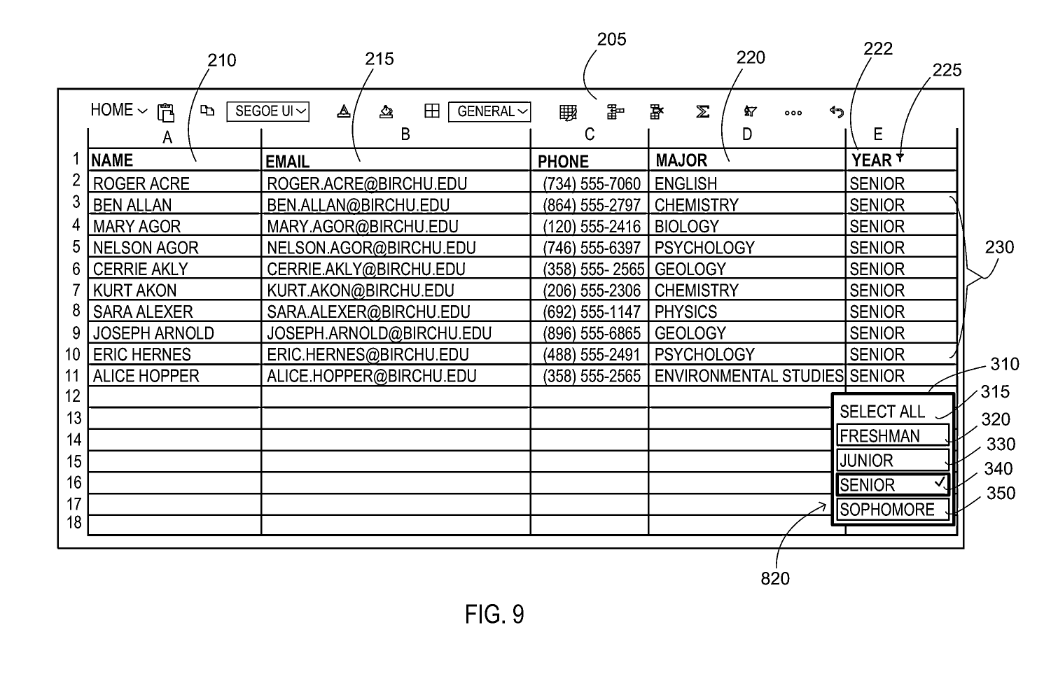

Referring now to FIGS. 8 and 9, according to an alternate embodiment, the slicer-style filtering user interface 310 may be moved from a starting position to a different position before the user interface is invoked and displayed on the document 205, or after a previously invoked and displayed user interface 310 has been dismissed. As illustrated in FIG. 8, according to this embodiment, a user may tap, select, or otherwise engage the icon 225 associated with the dismissed or un-invoked slicer-style filtering user interface 310, and the user may drag or otherwise move the icon 225 to a different location 820 for depositing the user interface 310 at a secondary docked position, as illustrated in FIG. 9.

According to one embodiment, when the user selects the icon 225 for moving the user interface 310, as illustrated in FIG. 8, the user interface 310 automatically displays, and the displayed user interface 310 is moved to the different position 820, as illustrated in FIG. 9. Alternatively, dragging the icon 225 from a starting position 810 to a different position 820 may drag only an instance of the icon 225 to the different position 820, wherein a selection of the dragged icon 225 at the different position 820 must be received to actually invoke and display the user interface 310 at the different position. According to yet another embodiment, upon selection of the icon 225 for moving the user interface 310 to a different location, a grayed out, ghosted, dotted line version, or other visual representation of the user interface 310 may be shown moving across the document 205 until the user reaches the different location and releases the tap and hold, click and hold, or the like associated with the icon 225. When the icon 225 is released, a full invocation and display of the user interface 310 may be presented at the different location.

The filter icon 225 is typically positioned next to the column headers in a spreadsheet document 205, as illustrated in FIG. 8. However, as should be appreciated, the filter icon may be located in a different location for data in a different type of document, and moving the user interface according to this embodiment may include dragging and dropping the filter icon from whatever position in which it is located according to the document in which it is positioned.

According to an embodiment, the filtering properties available from the user interface 310 will remain available in the user interface 310 regardless of the position to which the user interface 310 is moved. According to an alternate embodiment, moving the user interface 310 onto a different data range, for example, moving the user interface 310 onto the example column A in which example student names are listed may automatically cause the user interface 310 to be re-invoked to include filtering properties that may be utilized in association with the data at the position to which the user interface 310 has been moved.

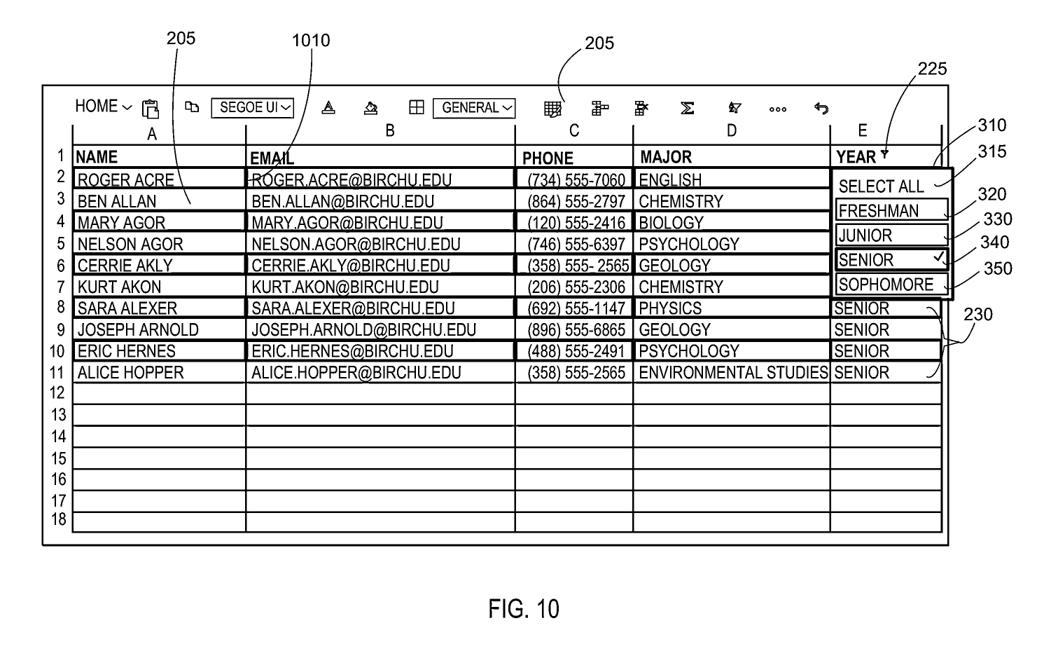

Referring now to FIG. 10, according to embodiments of the present invention, a variety of themes and/or styles may be applied to data contained in the displayed document 205. For example, the displayed document 205 may have been formatted with various colors, styles, and the like for creating a document theme associated with a given organization, or as desired by a user. For example, following from the example student information illustrated in the document 205, the document may have been themed to include school colors, wherein every other row of data is bordered by alternating colors associated with the example school. For example, referring to FIG. 10, a first row 210 in the document 205 is formatted according to a first style, a second row 1020 is formatted according to a second style, and so on. According to embodiments, when the slicer-style filtering user interface 310 is invoked and displayed in association with a document having an applied formatting theme, the formatting theme may be automatically applied to the invoked and displayed user interface 310 so that user interface 310 is displayed according to the same theme applied to the rest of the document to produce a more pleasing visual appearance for the user interface 310 when it is displayed.

As understood by those skilled in the art, in some situations, more advanced data filtering may be required given the nature of one or more data ranges. For example, a data range may include multiple sets of data, for example, a single data range may include multiple columns and/or rows of data, a data range may include multiple types of data, for example, text items, dates, currency values, quantity values, and the like. In such situations, the slicer-style filtering user interface 310 may include the availability of multiple filtering properties, and may be enabled to provide different types of filtering, for example, conditional filtering.

Referring now to FIG. 11, an example document 1110 is illustrated in an example spreadsheet user interface 1105 that contains data of different types including textual data and numeric data. A slicer-style filtering user interface 310 is invoked in a data range positioned in column C of the example spreadsheet document 1110 adjacent to a set of data associated with annual expenses for a science team. For the data range associated with the invoked user interface 310, both textual data and numeric based data are included. For example, the data range including the annual expenses text and numeric data may be a spreadsheet table that contains multiple types of data. Thus, invocation and display of the user interface 310, as illustrated in FIG. 11, may be for purposes of filtering both textual and numeric data contained in the selected data range.

Referring still to FIG. 11, an alphabetic filtering tab 1125 is illustrated and a numeric filtering tab 1130 is illustrated. According to the illustrated embodiment, the user interface 310 may be utilized for filtering and/or sorting both text based data and numeric based data, as desired. The illustrated instance of the user interface 310 shows that the present invocation of the data is associated with numeric data, wherein tiles 1120 showing dollar amounts are displayed in the invoked user interface 310. In the present invocation instance of the user interface 310, the user may filter data in the selected data range according to the numeric based dollar amounts associated with each data item in the selected data range. As described above with reference to FIGS. 2-5, the user may filter the data based on a numeric based filtering property by selecting one or more of the tiles 1120 for filtering the data, as desired.

Alternatively, if the user decides to filter the data contained in the selected data range according to an alphabetic or textual based filtering property, the user may select the alphabetic based filtering property button, control or tab 1125 illustrated in the user interface 310, and the tiles 1120 illustrated in the user interface 310 will be dynamically changed to tiles containing filtering properties associated with the alphabetic or textual based data contained in the selected data range. According to one embodiment, the number of tiles and identifications on the tiles will be changed to reflect the number of different filtering properties and identified data items in the data range associated with the second filtering type.

The user may then filter the data items contained in the selected data range based on one or more alphabetic or textual based filtering properties, as described herein. As should be appreciated, the example alphabetic filtering button 1125 and numeric filtering button 1130 are for purposes of example only and are not exhaustive of the selectable functionality controls that may be available in the user interface 310 for a variety of different filtering properties. As described above, if the filtering user interface 310 is displayed in a small form manner, the user may be required to horizontally pan or vertically scroll the contents of the user interface 310 to locate additional filtering properties of one or more types that may be applied to a selected data range.

Referring still to FIG. 11, a sorting control 1140 is illustrated next to the column header above the selected data range. According to embodiments, in addition to displaying the filter tiles 1120 in the user interface 310 according to various filter properties, the underlying data may be sorted by selection of the sorting icon 1140, and the displayed filtering tiles will be rearranged according to the sorting property applied to the underlying data.

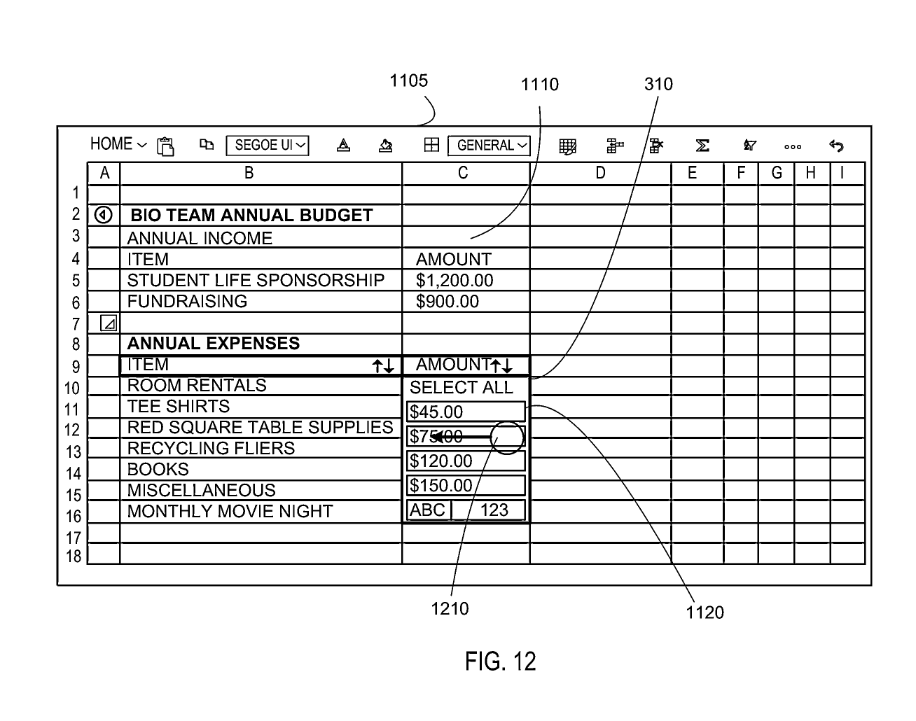

Referring to FIG. 12, according to another embodiment, instead of selecting either the alphabetic filter property button 1125 or the numeric filter property button 1135, a user may switch from one filter property to another by tapping and swiping inside the user interface 310, as illustrated in FIG. 12. For example, a touch point 1210 is illustrated where a user touches inside the user interface 310 on the right side of the user interface 310 followed by a swipe to the left to change the filter property from a numeric filter property to an alphabetic filter property. As should be appreciated, if the user interface 310 includes more types of filtering properties than may be displayed in the user interface 310, such a touch and swipe motion may result in a panning of the displayed end user interface 310. Alternatively, according to embodiments, at any given moment, the data displayed in the user interface 310 may be docked or set in a static display, and a touch and swiping motion, as illustrated in FIG. 12, may result in switching from one filtering property to another, as described herein.

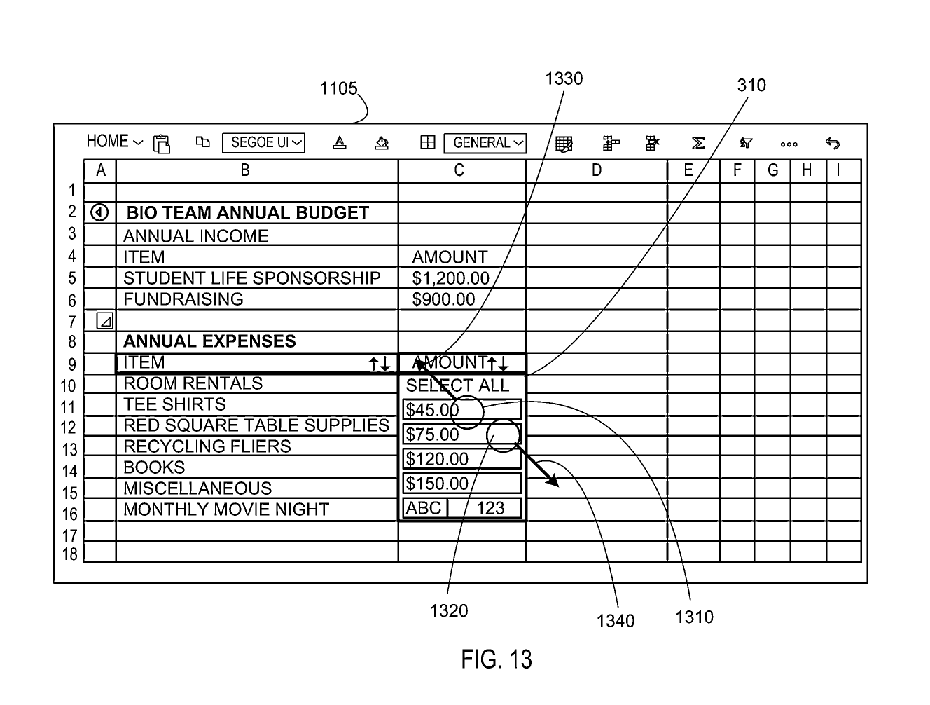

Referring now to FIG. 13, according to another embodiment, a pinch and push or pinch and pull movement is illustrated for changing from one filtering property to another filtering property, as described above with reference to FIGS. 11 and 12. According to this embodiment, a user may pinch and expand two touch points 1320 in the invoked and displayed user interface 310 for causing a switch from one filtering property to another filtering type or filtering property, as described herein.

Having described an example operating environment and various aspects of embodiments of the present invention above with reference to FIGS. 1 through 13, FIG. 14 is a flowchart illustrating a method for providing and utilizing a slicer-style filtering user interface. The routine 1400 begins at start operation 1405 and proceeds to operation 1410 where an electronic document, for example, a spreadsheet document 205 is received in an application user interface 207, as illustrated and described herein.

At operation 1415, a selection of a filter icon 225 is received for invoking and displaying a slicer-style filtering user interface. At operation 1420, the slicer-style filtering user interface 310 is displayed at the selected data range, and a current filtering state for the selected data range is displayed by highlighting or other visual indication associated with a tile in the user interface associated with the current filtering state.

At operation 1425, the user may select one or more additional filter tiles displayed in the user interface 310, or alternatively, the user may select the “Select All” button for selecting all filtering tiles displayed in the user interface 310. As a result, the underlying data is filtered according to the filtering properties associated with the selected filter tiles.

At operation 1430, one or more of the previously selected filter tiles may be de-selected, and filtering applied to the data in the selected data range is dynamically filtered according to the present filter properties now applied to the selected data range. As described herein, at any given point, a review of the selected filter tiles may alert the user as to the present filter state of the selected data range.

At operation 1435, a move action is received on the filtering user interface 310 for moving the user interface 310 from a starting location to a different location, as described above with reference to FIGS. 6 and 7. At operation 1440, the filtering user interface 310 is docked at the new location. At operation 1445, an action is received for moving the user interface 310 by moving the filter icon 225 from a starting location to a different location, and at operation 1450, the user interface 310 and/or the icon 225 is positioned at the different location, as described above with reference to FIGS. 8 and 9.

At operation 1455, a selection is received for changing the invoked and displayed user interface 310 from one filter type to a second filter type, as described above with reference to FIGS. 11-13. At operation 1460, the filter type associated with the user interface 310 is changed, and the tiles contained in the user interface 310 are displayed according to the filter properties contained in the selected data range to allow the user to immediately realize the current filter state of the selected data range according to the newly selected filter type.

The method ends at operation 1495.

While the invention has been described in the general context of program modules that execute in conjunction with an application program that runs on an operating system on a computer, those skilled in the art will recognize that the invention may also be implemented in combination with other program modules. Generally, program modules include routines, programs, components, data structures, and other types of structures that perform particular tasks or implement particular abstract data types.

The embodiments and functionalities described herein may operate via a multitude of computing systems including, without limitation, desktop computer systems, wired and wireless computing systems, mobile computing systems (e.g., mobile telephones, netbooks, tablet or slate type computers, notebook computers, and laptop computers), handheld devices, multiprocessor systems, microprocessor-based or programmable consumer electronics, minicomputers, and mainframe computers.

In addition, the embodiments and functionalities described herein may operate over distributed systems (e.g., cloud-based computing systems), where application functionality, memory, data storage and retrieval and various processing functions may be operated remotely from each other over a distributed computing network, such as the Internet or an intranet. User interfaces and information of various types may be displayed via on-board computing device displays or via remote display units associated with one or more computing devices. For example user interfaces and information of various types may be displayed and interacted with on a wall surface onto which user interfaces and information of various types are projected. Interaction with the multitude of computing systems with which embodiments of the invention may be practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

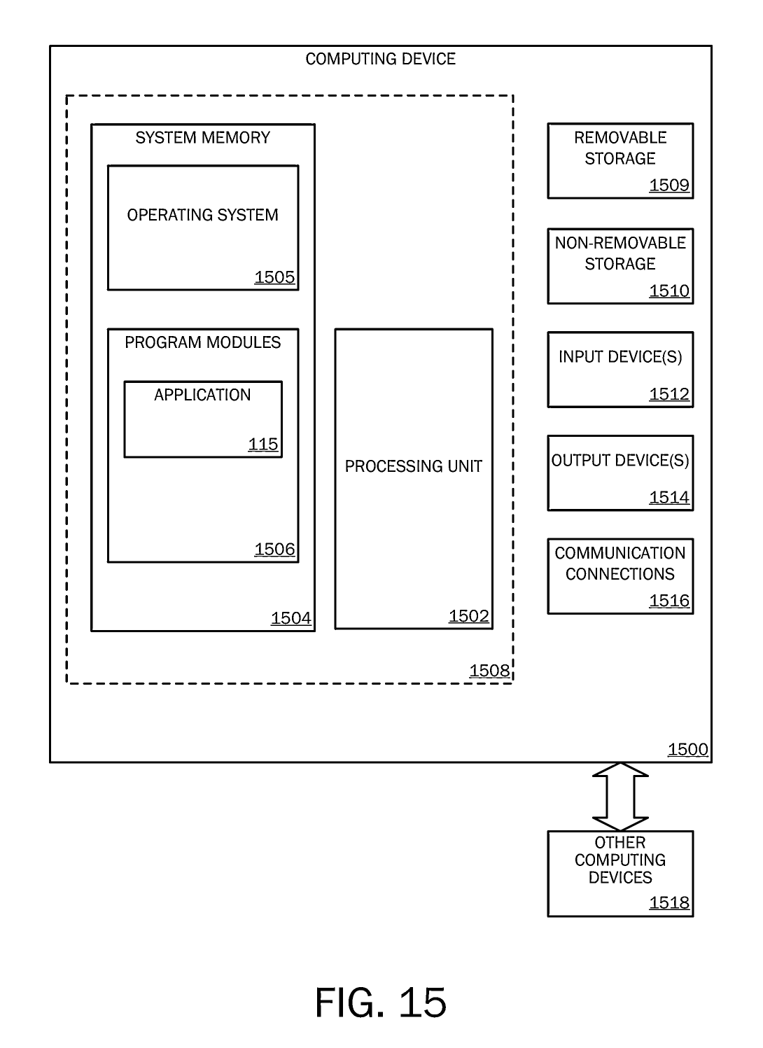

FIGS. 15-17 and the associated descriptions provide a discussion of a variety of operating environments in which embodiments of the invention may be practiced. However, the devices and systems illustrated and discussed with respect to FIGS. 15-17 are for purposes of example and illustration and are not limiting of a vast number of computing device configurations that may be utilized for practicing embodiments of the invention, described herein.

FIG. 15 is a block diagram illustrating physical components (i.e., hardware) of a computing device 1500 with which embodiments of the invention may be practiced. The computing device components described below may be suitable for the computing devices 105, 110, 120, 125, 135 described above. In a basic configuration, the computing device 1500 may include at least one processing unit 1502 and a system memory 1504. Depending on the configuration and type of computing device, the system memory 1504 may comprise, but is not limited to, volatile storage (e.g., random access memory), non-volatile storage (e.g., read-only memory), flash memory, or any combination of such memories. The system memory 1504 may include an operating system 1505 and one or more program modules 1506 suitable for running a variety of applications 1520. The operating system 1505, for example, may be suitable for controlling the operation of the computing device 1500. Furthermore, embodiments of the invention may be practiced in conjunction with a graphics library, other operating systems, or any other application program and is not limited to any particular application or system. This basic configuration is illustrated in FIG. 15 by those components within a dashed line 1508. The computing device 1500 may have additional features or functionality. For example, the computing device 1500 may also include additional data storage devices (removable and/or non-removable) such as, for example, magnetic disks, optical disks, or tape. Such additional storage is illustrated in FIG. 15 by a removable storage device 1509 and a non-removable storage device 1510.

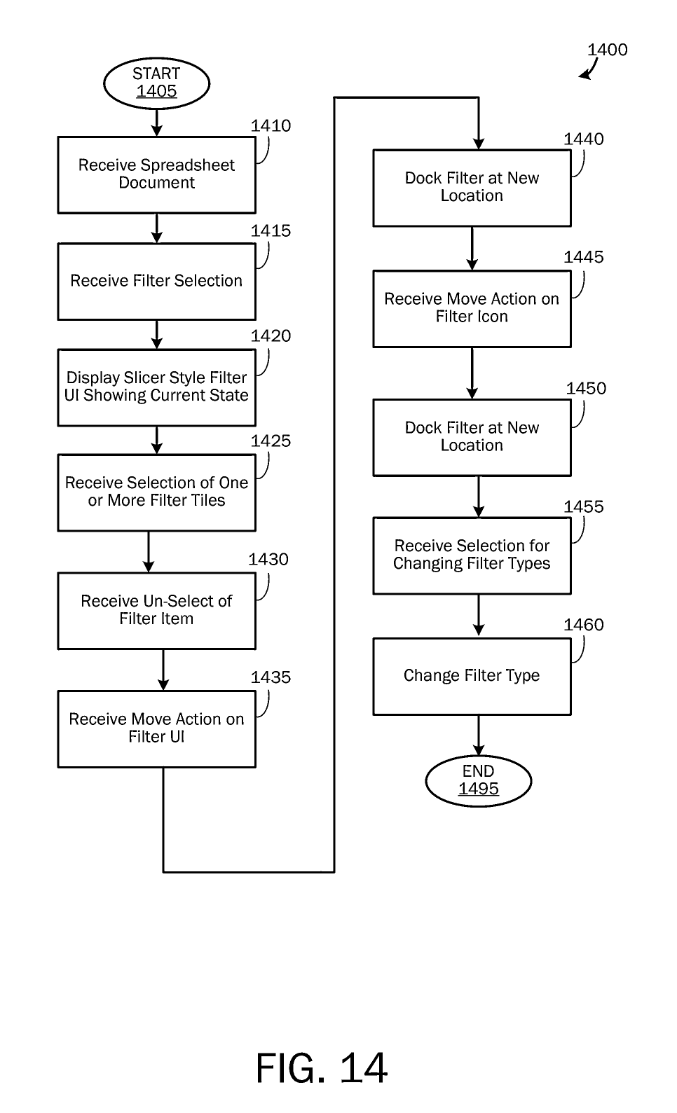

As stated above, a number of program modules and data files may be stored in the system memory 1504. While executing on the processing unit 1502, the program modules 1506 may perform processes including, but not limited to, one or more of the stages of the method 1400 illustrated in FIG. 14. Other program modules that may be used in accordance with embodiments of the present invention may include applications, such as, notes applications, Internet browser applications, electronic mail and contacts applications, word processing applications, spreadsheet applications, database applications, slide presentation applications, drawing or computer-aided application programs, etc.

Furthermore, embodiments of the invention may be practiced in an electrical circuit comprising discrete electronic elements, packaged or integrated electronic chips containing logic gates, a circuit utilizing a microprocessor, or on a single chip containing electronic elements or microprocessors. For example, embodiments of the invention may be practiced via a system-on-a-chip (SOC) where each or many of the components illustrated in FIG. 15 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to use of web page content may be operated via application-specific logic integrated with other components of the computing device 1500 on the single integrated circuit (chip). Embodiments of the invention may also be practiced using other technologies capable of performing logical operations such as, for example, AND, OR, and NOT, including but not limited to mechanical, optical, fluidic, and quantum technologies. In addition, embodiments of the invention may be practiced within a general purpose computer or in any other circuits or systems.

The computing device 1500 may also have one or more input device(s) 1512 such as a keyboard, a mouse, a pen, a sound input device, a touch input device, etc. The output device(s) 1514 such as a display, speakers, a printer, etc. may also be included. The aforementioned devices are examples and others may be used. The computing device 1500 may include one or more communication connections 1516 allowing communications with other computing devices 1518. Examples of suitable communication connections 1516 include, but are not limited to, RF transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 1504, the removable storage device 1509, and the non-removable storage device 1510 are all computer storage media examples (i.e., memory storage.) Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 1500. Any such computer storage media may be part of the computing device 1500.

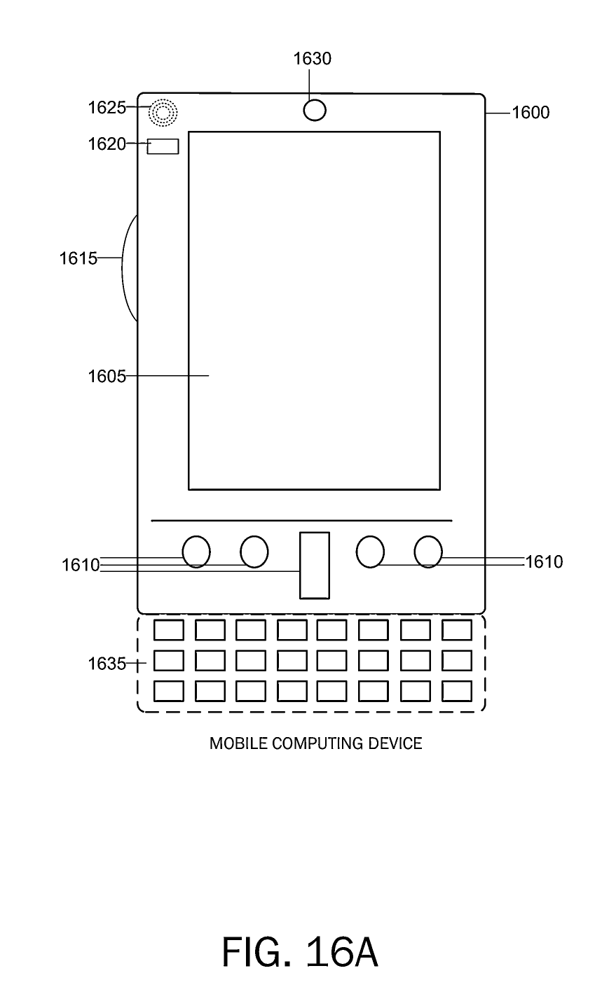

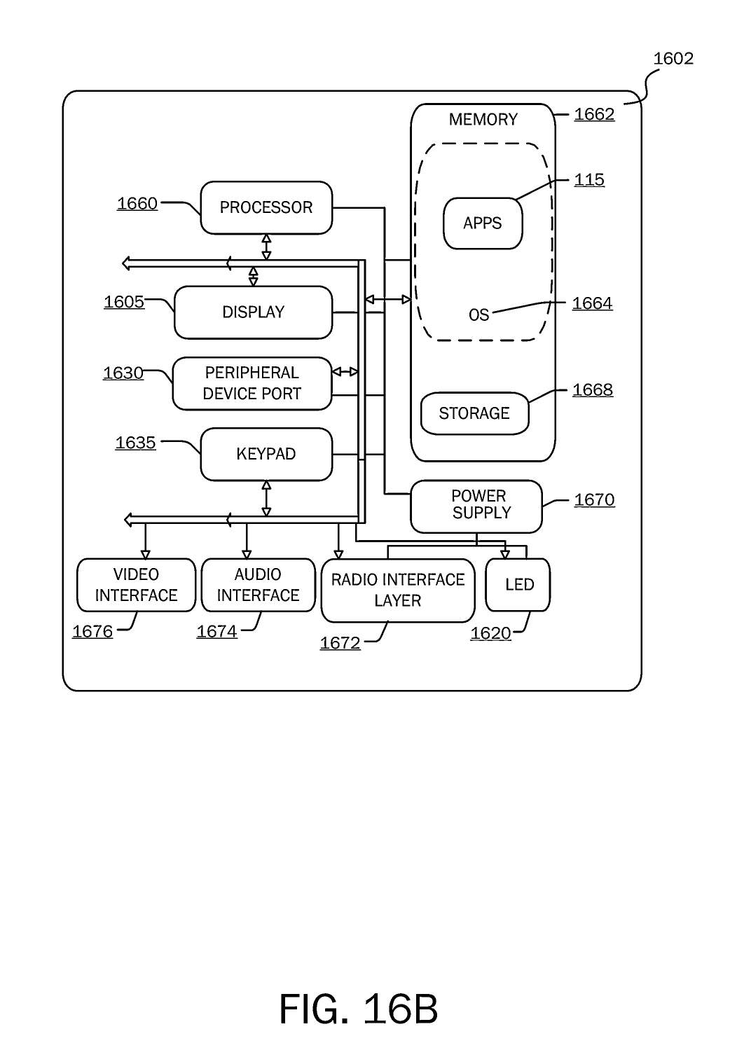

FIGS. 16A and 16B illustrate a mobile computing device 1600, for example, a mobile telephone, a smart phone 110, a tablet-style personal computer 105, a laptop computer, and the like, with which embodiments of the invention may be practiced. With reference to FIG. 16A, one embodiment of a mobile computing device 1600 for implementing the embodiments is illustrated. In a basic configuration, the mobile computing device 1600 is a handheld computer having both input elements and output elements. The mobile computing device 1600 typically includes a display 1605 and one or more input buttons 1610 that allow the user to enter information into the mobile computing device 1600. The display 1605 of the mobile computing device 1600 may also function as an input device (e.g., a touch screen display). If included, an optional side input element 1615 allows further user input. The side input element 1615 may be a rotary switch, a button, or any other type of manual input element. In alternative embodiments, mobile computing device 1600 may incorporate more or less input elements. For example, the display 1605 may not be a touch screen in some embodiments. In yet another alternative embodiment, the mobile computing device 1600 is a portable phone system, such as a cellular phone. The mobile computing device 1600 may also include an optional keypad 1635. Optional keypad 1635 may be a physical keypad or a “soft” keypad generated on the touch screen display. In various embodiments, the output elements include the display 1605 for showing a graphical user interface (GUI), a visual indicator 1620 (e.g., a light emitting diode), and/or an audio transducer 1625 (e.g., a speaker). In some embodiments, the mobile computing device 1600 incorporates a vibration transducer for providing the user with tactile feedback. In yet another embodiment, the mobile computing device 1600 incorporates input and/or output ports, such as an audio input (e.g., a microphone jack), an audio output (e.g., a headphone jack), and a video output (e.g., a HDMI port) for sending signals to or receiving signals from an external device.

FIG. 16B is a block diagram illustrating the architecture of one embodiment of a mobile computing device. That is, the mobile computing device 1600 can incorporate a system (i.e., an architecture) 1602 to implement some embodiments. In one embodiment, the system 1602 is implemented as a “smart phone” capable of running one or more applications (e.g., browser, e-mail, calendaring, contact managers, messaging clients, games, and media clients/players). In some embodiments, the system 1602 is integrated as a computing device, such as an integrated personal digital assistant (PDA) and wireless phone.

One or more application programs may be loaded into the memory 1662 and run on or in association with the operating system 1664. Examples of the application programs include phone dialer applications, e-mail applications, personal information management (PIM) applications, word processing applications, spreadsheet applications, Internet browser applications, notes applications, messaging applications, and so forth. The system 1602 also includes a non-volatile storage area 1668 within the memory 1662. The non-volatile storage area 1668 may be used to store persistent information that should not be lost if the system 1602 is powered down. The application programs may use and store information in the non-volatile storage area 1668, such as e-mail or other messages used by an e-mail application, and the like. A synchronization application (not shown) also resides on the system 1602 and is programmed to interact with a corresponding synchronization application resident on a host computer to keep the information stored in the non-volatile storage area 1668 synchronized with corresponding information stored at the host computer. As should be appreciated, other applications may be loaded into the memory 1662 and run on the mobile computing device 1600.

The system 1602 has a power supply 1670, which may be implemented as one or more batteries. The power supply 1670 might further include an external power source, such as an AC adapter or a powered docking cradle that supplements or recharges the batteries.

The system 1602 may also include a radio 1672 that performs the function of transmitting and receiving radio frequency communications. The radio 1672 facilitates wireless connectivity between the system 1602 and the “outside world,” via a communications carrier or service provider. Transmissions to and from the radio 1672 are conducted under control of the operating system 1664. In other words, communications received by the radio 1672 may be disseminated to the application programs 120 via the operating system 1664, and vice versa.

The visual indicator 1620 may be used to provide visual notifications and/or an audio interface 1674 may be used for producing audible notifications via the audio transducer 1625. In the illustrated embodiment, the visual indicator 1620 is a light emitting diode (LED) and the audio transducer 1625 is a speaker. These devices may be directly coupled to the power supply 1670 so that when activated, they remain on for a duration dictated by the notification mechanism even though the processor 1660 and other components might shut down for conserving battery power. The LED may be programmed to remain on indefinitely until the user takes action to indicate the powered-on status of the device. The audio interface 1674 is used to provide audible signals to and receive audible signals from the user. For example, in addition to being coupled to the audio transducer 1625, the audio interface 1674 may also be coupled to a microphone to receive audible input, such as to facilitate a telephone conversation. In accordance with embodiments of the present invention, the microphone may also serve as an audio sensor to facilitate control of notifications, as will be described below. The system 1602 may further include a video interface 1676 that enables an operation of an on-board camera 1630 to record still images, video stream, and the like.

A mobile computing device 1600 implementing the system 1602 may have additional features or functionality. For example, the mobile computing device 1600 may also include additional data storage devices (removable and/or non-removable) such as, magnetic disks, optical disks, or tape. Such additional storage is illustrated in FIG. 16B by the non-volatile storage area 1668.

Data/information generated or captured by the mobile computing device 1600 and stored via the system 1602 may be stored locally on the mobile computing device 1600, as described above, or the data may be stored on any number of storage media that may be accessed by the device via the radio 1672 or via a wired connection between the mobile computing device 1600 and a separate computing device associated with the mobile computing device 1600, for example, a server computer in a distributed computing network, such as the Internet. As should be appreciated such data/information may be accessed via the mobile computing device 1600 via the radio 1672 or via a distributed computing network. Similarly, such data/information may be readily transferred between computing devices for storage and use according to well-known data/information transfer and storage means, including electronic mail and collaborative data/information sharing systems.

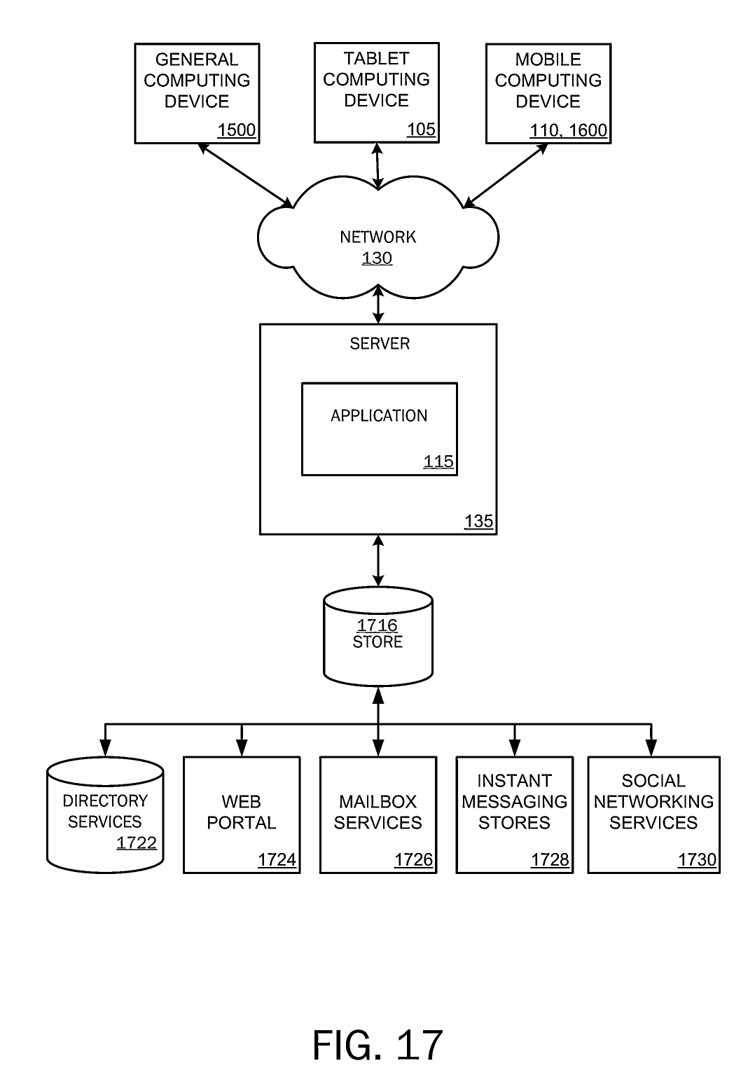

FIG. 17 illustrates one embodiment of the architecture of a system for providing data filtering, as described above. Content developed, interacted with, or edited in association with embodiments of the invention may be stored in different communication channels or other storage types. For example, various documents and stored content items may be stored using a directory service 1722, a web portal 1724, a mailbox service 1726, an instant messaging store 1728, or a social networking site 1730. The data filtering functionality described herein may use any of these types of systems or the like for enabling data utilization, as described herein. A server 135 may provide output of the data filtering functionality to clients. As one example, the server 135 may be a web server providing the data filtering and associated functionality over the web. The server 135 may provide the output of the data filtering and associated functionality over the web to clients through a network 130. By way of example, the client computing device may be implemented and embodied in a personal computer 1500, a tablet computing device 105 and/or a mobile computing device (e.g., a smart phone) 110, or other computing device. Any of these embodiments of the client computing device 1500, 105, 110, 120, 125, 135 may obtain content from the store 1716.

Embodiments of the present invention, for example, are described above with reference to block diagrams and/or operational illustrations of methods, systems, and computer program products according to embodiments of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more embodiments provided in this application are not intended to limit or restrict the scope of the invention as claimed in any way. The embodiments, examples, and details provided in this application are considered sufficient to convey possession and enable others to make and use the best mode of claimed invention. The claimed invention should not be construed as being limited to any embodiment, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate embodiments falling within the spirit of the broader aspects of the general inventive concept embodied in this application that do not depart from the broader scope of the claimed invention.

We claim:

1. A computer-implemented method for filtering data in an electronic document, comprising:
receiving a selection for filtering a data range in an electronic document;
displaying a filtering user interface in the electronic document for filtering the data range;
displaying in the filtering user interface one or more tiles associated with one or more filtering properties that may be applied to the data range;
receiving a selection in the filtering user interface for changing a filtering type of the filtering user interface from a first type to a second type; and
changing a filtering type of the filtering user interface from the first type to the second type.

2. The method of claim 1, in response to changing a filtering type of the filtering user interface from the first type to the second type, automatically changing the one or more tiles displayed in the filtering user interface such that a number of the one or more tiles and an identification for each of the one or more tiles is associated with the second filtering type.

3. The method of claim 2, receiving a selection in the filtering user interface for changing a filtering type of the filtering user interface from a first type to a second type is in response to moving the filtering user interface onto a second data range having one or more data items of the second filtering type.

4. The method of claim 1, wherein receiving a selection in the filtering user interface for changing a filtering type of the filtering user interface from a first type to a second type includes receiving a selection of a selectable control displayed in the filtering user interface.

5. The method of claim 1, wherein receiving a selection in the filtering user interface for changing a filtering type of the filtering user interface from a first type to a second type includes receiving a gesture in the filtering user interface.

6. The method of claim 1, wherein displaying in the filtering user interface one or more tiles associated with one or more filtering properties that may be applied to the data range includes displaying the one or more tiles in an order corresponding to a present sorting order of one or more data items contained in the data range.

7. The method of claim 1, wherein displaying in the filtering user interface one or more tiles associated with one or more filtering properties that may be applied to the data range, further comprises visually distinguishing one or more of the one or more tiles that are associated with a filtering property presently applied to the data range.

8. The method of claim 7, further comprising:
receiving a selection of at least one tile from the one or more tiles not associated with a filtering property presently applied to the data range; and
automatically applying to the data range a filtering property associated with the selected at least one tile.

9. The method of claim 8, further comprising visually distinguishing the selected at least one tile from the one or more tiles, such that any of the one or more tiles associated with a filtering property applied to the data range is visually distinguished from any of the one or more tiles not associated with a filtering property applied to the data range.

10. The method of claim 7, wherein visually distinguishing the selected at least one tile from the one or more tiles that are associated with a filtering property presently applied to the data range includes providing a present filtering state for the data range.

11. The method of claim 1, wherein prior to displaying a filtering user interface in the electronic document further comprising receiving a selection for moving the filtering user interface from a first position in the electronic document to a second position in the electronic document.

12. The method of claim 11, wherein receiving a selection for moving the filtering user interface from a first position in the electronic document to a second position in the electronic document includes receiving a selection for undocking the filtering user interface from the first position and docking the filtering user interface at the second position.

13. The method of claim 11, wherein receiving the selection for moving the filtering user interface from a first position in the electronic document to a second position in the electronic document includes receiving a dragging of the filtering user interface from the first position and a dropping of the filtering user interface at the second position.

14. The method of claim 11, wherein receiving a selection for moving the filtering user interface from a first position in the electronic document to a second position in the electronic document includes receiving a selection for dragging a selectable icon associated with the filtering user interface from the first position and a dropping of the selectable icon at the second position.

15. The method of claim 14, further comprising displaying the filtering user interface at the second position after the selectable icon is dropped at the second position.

16. The method of claim 1, wherein displaying in the filtering user interface one or more tiles associated with one or more filtering properties includes displaying one or more tiles associated with one or more default filtering properties associated with the data range.

17. The method of claim 1, wherein displaying a filtering user interface in the electronic document for filtering the data range includes displaying the filtering user interface according to a display theme applied to the electronic document.

18. A computer-implemented method for filtering data in an electronic document, comprising:
receiving a selection for filtering a data range in an electronic document;
displaying a filtering user interface in the electronic document for filtering the data range;
displaying in the filtering user interface one or more tiles associated with one or more filtering properties that may be applied to the data range;
displaying the one or more tiles in an order corresponding to a present sorting order of one or more data items contained in the data range; and
visually distinguishing at least one tile from the one or more tiles that are associated with a filtering property presently applied to the data range.

19. The method of claim 18, further comprising:
receiving a selection in the filtering user interface for changing a filtering type of the filtering user interface from a first type to a second type; and
changing a filtering type of the filtering user interface from the first type to the second type.

20. A system for filtering data in an electronic document, comprising:
one or more processors; and
a memory coupled to the one or more processors, the one or more processors operable to:
receive a selection for filtering a data range in an electronic document;
display a filtering user interface in the electronic document for filtering the data range;
display in the filtering user interface one or more tiles associated with one or more filtering properties that may be applied to the data range;
receive a selection of at least one tile from the one or more tiles not associated with a filtering property presently applied to the data range; and
automatically apply to the data range a filtering property associated with the selected at least one tile from the one or more tiles.
